(19) United States
(12) Patent Application Publication
(10) Pub. No.: US 2006/0194696 A1
(43) Pub. Date: Aug. 31, 2006

(54) Oxygen-scavenging packaging

(76) Inventors: James Robert Durrant, London (GB); Andrew Mills, Glasgow (GB); Joachim Hans Georg Steinke, London (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/520,608

(22) PCT Filed: Jul. 7, 2003
(86) PCT No.: PCT/GB03/02950

§ 371 Date: Jan. 3, 2006

(30) Foreign Application Priority Data
Jul. 8, 2002 (GB) 0215713.9

(51) Int. Cl. B01J 20/26; C01B 3/00

(52) U.S. Cl. 502/402; 252/188.28

(57) ABSTRACT

Packaging including an oxygen-scavenging element including an activatable semiconductor, in embodiments, one or both of a photo-activatable semiconductor activatable by ultra-bandgap light or an electro-activatable semiconductor activatable by application of an electrical bias, which, when activated, acts to scavenge oxygen from its surrounding environment.

The present invention relates to packaging including an oxygen-scavenging element for scavenging oxygen from its surrounding environment, in particular an oxygen-scavenging element including an activatable semiconductor, and especially a photo-activatable semiconductor.

In semiconductor photo-catalysis, a semiconductor, typically an oxide such as titanium (IV) oxide (TiO₂), zinc (II) oxide (ZnO) or tungsten (IV) oxide (WO₃), is activated with ultra-bandgap light. Irradiation of a semiconductor with photons of such light acts to promote electrons from the valence band to the largely-unoccupied conductance band of the semiconductor, and, in so doing, creates holes in the valence band. These electron-hole pairs have a tendency to re-combine. However, the generated electrons can act to reduce chemical species absorbed on the surface of the semiconductor, and the holes can act to oxidize chemical species absorbed on the surface of the semiconductor.

Semiconductor photo-catalysis is finding increased application in the mineralization of organic species in organic systems, with the photo-generated holes acting to oxidize the organic species. An organic species acting in this manner is sometimes referred to as a sacrificial electron donor.

The present inventors have recognized that semiconductor photo-catalysis, and indeed any activatable semiconductors, can be utilized to de-oxygenate a closed environment, as an incidental consequence of photo-catalytic activity in the destruction of organic species is the consumption of molecular oxygen, with the photo-generated electrons acting to reduce the available oxygen. This consumption of oxygen has previously been noted, but its technological significance has not been appreciated. Furthermore, semiconductors can also consume oxygen through a photochemical process even in the absence of an organic species through the creation of surface peroxide species.

In particular, the present inventors have demonstrated the de-oxygenation of a closed environment by irradiation of a nanocrystalline TiO₂ photo-catalyst both in the presence and absence of a sacrificial electron donor.

A de-oxygenated environment is a pre-requisite for the efficient operation of a range of different systems. Two such systems will now be outlined by way of example.

Electronic and opto-electronic devices are sensitive to environmental conditions, and in particular oxygen penetration. This sensitivity is particularly critical for opto-electronic devices, where exposure of the device to radiation or radiation generated by the device exacerbates the problem. Such sensitivity is particularly critical for molecular and polymer-based electronic and opto-electronic devices.

Conventionally, such devices include a barrier layer in an attempt to prevent the penetration of chemical species, such as oxygen. More recently, in an attempt to prevent oxygen penetration, the devices have been provided with oxygen-absorbing layers. In addition, the fabrication environment for such devices may be required to be anaerobic.

In such devices, the present inventors have recognized that activatable semiconductors can be utilized to remove or at least reduce the concentration of available oxygen, thereby enhancing the stability of such devices. It is envisaged that the incorporation of an oxygen-scavenging element which includes an activatable semiconductor in such devices will reduce the environmental oxygen concentration to such an extent as to ease significantly the tolerance requirements for device encapsulation and fabrication.

Foodstuffs, pharmaceuticals, artefacts, such as museum pieces, and other items, such as artwork, metals and medical instruments, can also be particularly sensitive to oxygen; oxygen being essential for the metabolism of many common bacteria and moulds and leading to oxidative deterioration.

In most modern food packaging, foodstuffs are packaged in a controlled environment that contains significantly less oxygen than the 21% normally present in the atmosphere. This method of packaging is called modified atmosphere packaging (MAP). In most cases, a MAPed package is created by flushing the package with carbon dioxide or nitrogen. Foodstuffs packaged in a MAPed package stay fresher longer, typically three times longer, than when packaged in a non-MAPed package.

Oxygen scavengers, typically mild reducing agents, such as ascorbic acid or finely-divided iron, are usually contained in sachets and used extensively in packaging, particularly packaging in warm and humid conditions, such as the Far East. This is even the case for MAPed packages, for example, those generated by gas flushing which typically still contain between 1 and 2% oxygen. Such an oxygen concentration is sufficient for a number of microbes to thrive, especially under warm and humid conditions. The oxygen scavenger sachet industry is substantial, with over 10 billion units sold per annum in Japan alone.

For such packaging, the present inventors have recognized that activatable semiconductors can be utilized to remove or at least reduce the concentration of available oxygen in such packaging. It is envisaged that the incorporation of activatable semiconductors in packaging will eliminate or substantially reduce oxidative decay of a packaged item as compared to any of the existing packaging techniques. Notably, food will stay fresher for longer periods of time.

Furthermore, unlike conventional oxygen scavengers, oxygen scavenging by activatable semiconductors will function for longer periods of time, and does not require any special packaging environment. In addition, for photo-activatable semiconductors, de-oxygenation can be performed simply by the application of light, with such de-oxygenation providing for a high degree of controllability as the semiconductors are activated only by the application of ultra-bandgap light.

Accordingly, the present invention provides packaging including an oxygen-scavenging element including an activatable semiconductor which, when activated, acts to scavenge oxygen from its surrounding environment.

Preferably, the oxygen-scavenging element includes a sacrificial electron donor.

More preferably, the sacrificial electron donor comprises an organic material.

In one embodiment the organic material comprises a polymeric material.

Preferably, the polymeric material comprises PVA, PVC, PEG, polyethylene oxide, hydroxyethyl cellulose, or a mixture thereof.

In another embodiment the organic material comprises an amine.

Preferably, the amine comprises EDTA, triethylamine, or a mixture thereof.

In a further embodiment the organic material comprises an alcohol.

In a yet further embodiment the organic material comprises a thiol.

In a still yet further embodiment the organic material comprises an aldehyde.

In one embodiment the sacrificial electron donor comprises a liquid.

In another embodiment the sacrificial electron donor comprises a solid.

In a further embodiment the sacrificial electron donor comprises a gas.

In yet another embodiment the sacrificial electron donor comprises a vapor.

Preferably, the activatable semiconductor comprises a nanocrystalline semiconductor.

In a preferred embodiment the activatable semiconductor comprises an oxide semiconductor.

In one embodiment the semiconductor comprises TiO₂.

In another embodiment the semiconductor comprises ZnO.

In a further embodiment the semiconductor comprises WO₃.

In yet another embodiment the semiconductor comprises at least two of TiO₂, ZnO and WO₃.

In one embodiment the oxygen-scavenging element comprises a suspension containing an activatable semiconductor.

In another embodiment the oxygen-scavenging element comprises a paste containing an activatable semiconductor.

In a further embodiment the oxygen-scavenging element comprises a gel containing an activatable semiconductor.

In yet another embodiment the oxygen-scavenging element comprises a solid containing an activatable semiconductor.

In one preferred embodiment the oxygen-scavenging element comprises a block containing an activatable semiconductor.

In another preferred embodiment the oxygen-scavenging element comprises a layer containing an activatable semiconductor.

In a further preferred embodiment the oxygen-scavenging element comprises a powder containing an activatable semiconductor.

In one embodiment the activatable semiconductor comprises a photo-activatable semiconductor.

Preferably, the photo-activatable semiconductor is activatable by ultra-bandgap light.

In another embodiment the activatable semiconductor comprises an electro-activatable semiconductor.

Preferably, the electro-activatable semiconductor is activatable by application of an electrical bias.

The present invention also extends to a package packaging an item and including the above-described packaging.

Preferably, the package defines a closed environment in which the item is enclosed.

In one embodiment the oxygen-scavenging element comprises an encapsulating layer encapsulating at least a surface of the item.

In another embodiment the packaging comprises a film packaging defined at least in part by the oxygen-scavenging element.

In a further embodiment the packaging includes an open-topped container and the oxygen-scavenging element comprises a film which closes the container.

In yet another embodiment the packaging includes a closed container and the oxygen-scavenging element is disposed within the container.

In one embodiment the item comprises an electronic device.

In another embodiment the item comprises an opto-electronic device.

In one embodiment the item comprises a molecular device.

In another embodiment the item comprises a polymeric device.

In a further embodiment the item comprises a foodstuff.

The present invention further extends to use of an oxygen-scavenging element including an activatable semiconductor in packaging to scavenge oxygen from its surrounding environment when activated.

Preferred embodiments of the present invention will now be described hereinbelow by way of example only with reference to the accompanying drawings, in which:

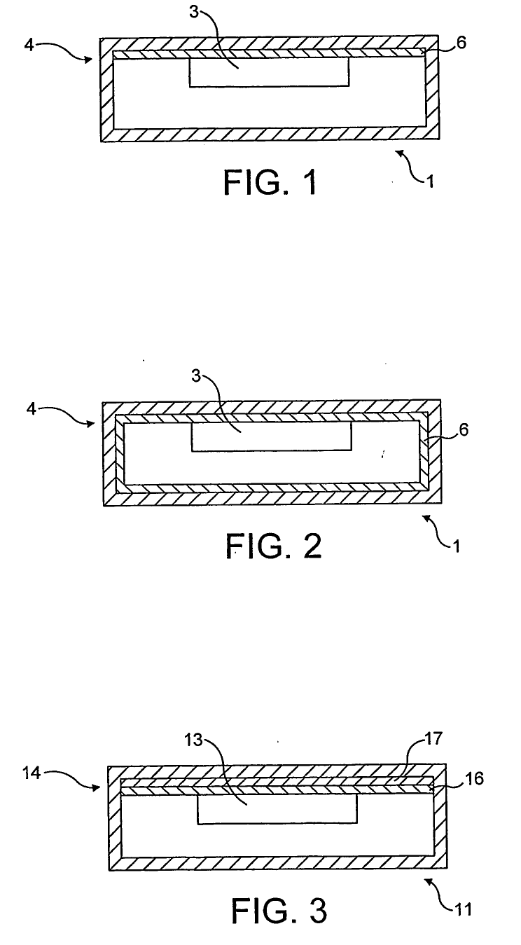

FIG. 1 illustrates a package in accordance with a first embodiment of the present invention;

FIG. 2 illustrates a package in accordance with a second embodiment of the present invention;

FIG. 3 illustrates a package in accordance with a third embodiment of the present invention;

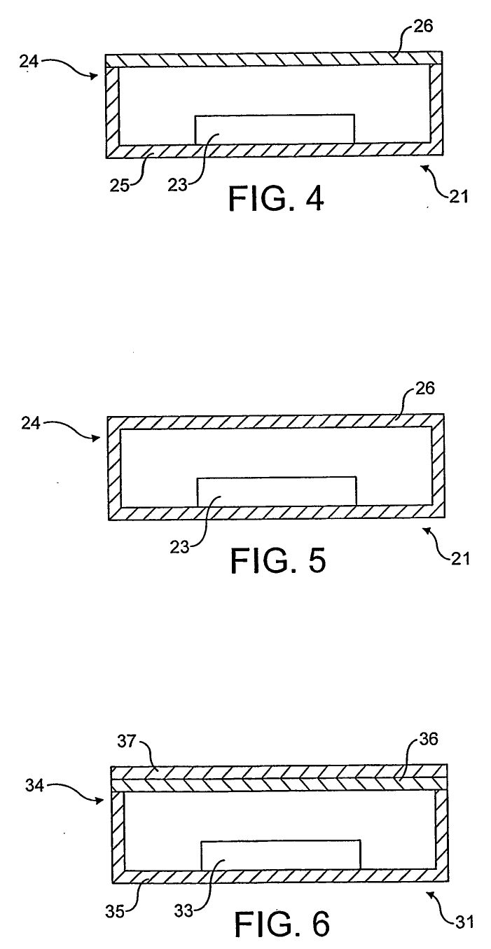

FIG. 4 illustrates a package in accordance with a fourth embodiment of the present invention;

FIG. 5 illustrates a package in accordance with a fifth embodiment of the present invention;

FIG. 6 illustrates a package in accordance with a sixth embodiment of the present invention;

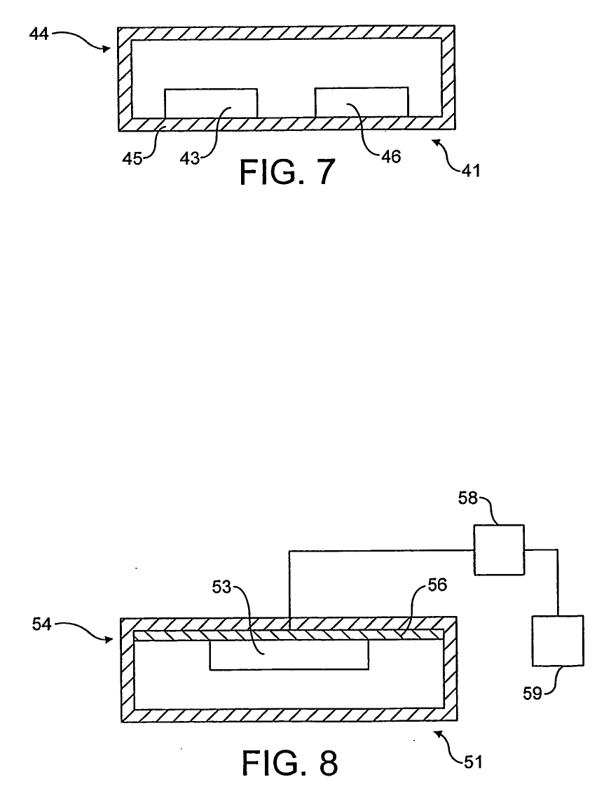

FIG. 7 illustrates a package in accordance with a seventh embodiment of the present invention;

FIG. 8 illustrates a package in accordance with an eighth embodiment of the present invention;

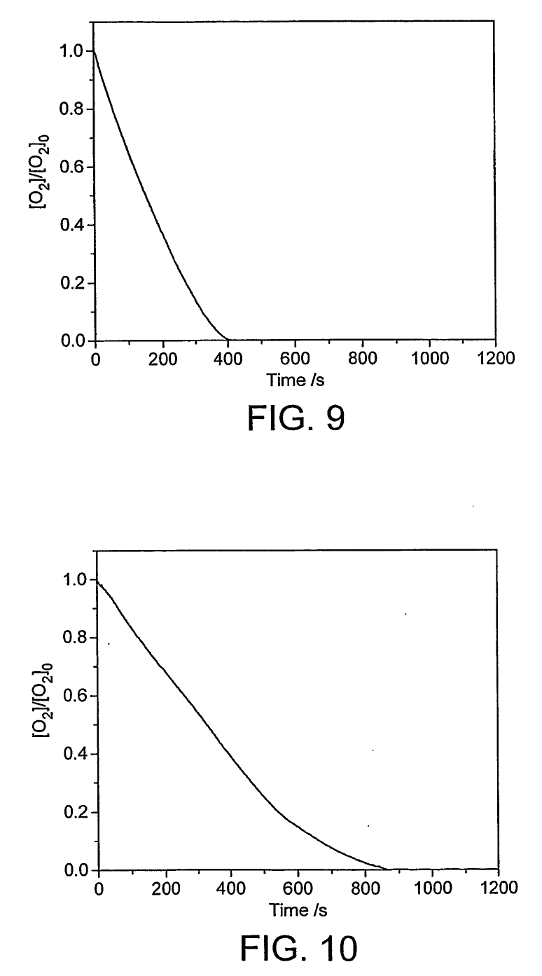

FIG. 9 illustrates a plot of the measured oxygen concentration as a function of the period of irradiation for packaging of one Example (Example 1) in accordance with the present invention; and

FIG. 10 illustrates a plot of the measured oxygen concentration as a function of the period of irradiation for packaging of another Example (Example 2) in accordance with the present invention.

FIG. 1 illustrates a package 1 in accordance with a first embodiment of the present invention.

The package 1 comprises an item 3, as a component, in this embodiment one of an electronic or opto-electronic device, and in particular one of a molecular or polymer-based electronic or opto-electronic device, and packaging 4 which includes an oxygen-scavenging element 6 including an activatable semiconductor, in this embodiment a layer encapsulating an active surface of the item 3, which is activatable to scavenge oxygen and prevent the penetration of oxygen to the active surface of the item 3.

In this embodiment the activatable semiconductor is a photo-activatable semiconductor, such as TiO₂, ZnO, WO₃ or any mixture thereof, which is activatable by ultra-bandgap light to scavenge available oxygen.

In this embodiment the oxygen-scavenging element 6 comprises a thin film.

In this embodiment the oxygen-scavenging element 6 comprises a layer of a nanocrystalline activatable semiconductor.

In another embodiment the oxygen-scavenging element 6 could comprise a layer comprising a mixture of a nanocrystalline activatable semiconductor and a sacrificial electron donor. In a preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

In a further embodiment the oxygen-scavenging element 6 could comprise a layer comprising a carrier and a nanocrystalline activatable semiconductor dispersed therein. In one embodiment the carrier comprises a polymeric material.

In one embodiment the carrier could be a sacrificial electron donor, preferably a polymeric material, such as PVA, PVC, PEG, polyethylene oxide, hydroxyethyl cellulose or a mixture thereof.

In another embodiment the oxygen-scavenging element 6 could include a sacrificial electron donor dispersed in the carrier. In a preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

In one alternative embodiment the oxygen-scavenging element 6 could be a separate component of the packaging 4 and supported by the item 3.

FIG. 2 illustrates a package 1 in accordance with a second embodiment of the present invention.

This package 1 is very similar to the package 1 of the above-described first embodiment, and thus, in order to avoid unnecessary duplication of description, only the differences will be described in detail, with like parts being designated by like reference signs.

This package 1 differs from the package 1 of the above-described first embodiment only in that the oxygen-scavenging element 6 completely encapsulates the item 3 and not only an active surface of the item 3.

FIG. 3 illustrates a package 11 in accordance with a third embodiment of the present invention.

The package 11 comprises an item 13, as a component, in this embodiment one of an electronic or opto-electronic device, and in particular one of a molecular or polymer-based electronic or opto-electronic device, and packaging 14 which includes an oxygen-scavenging element 16 including an activatable semiconductor, in this embodiment a layer encapsulating an active surface of the item 13, which is activatable to scavenge oxygen and prevent the penetration of oxygen to the active surface of the item 13, and a support 17 for supporting the oxygen-scavenging element 16.

In this embodiment the activatable semiconductor is a photo-activatable semiconductor, such as TiO₂, ZnO, WO₃ or any mixture thereof, which is activatable by ultra-bandgap light to scavenge available oxygen.

In this embodiment the oxygen-scavenging element 16 comprises a thin film.

In this embodiment the support 17 comprises a polymeric material. In one embodiment the support 17 is a sacrificial electron donor, preferably PVA, PVC, PEG, polyethylene oxide, hydroxyethyl cellulose or a mixture thereof.

In this embodiment the oxygen-scavenging element 16 comprises a layer of a nanocrystalline activatable semiconductor.

In another embodiment the oxygen-scavenging element 16 could comprise a layer comprising a mixture of a nanocrystalline activatable semiconductor and a sacrificial electron donor. In a preferred embodiment the sacrificial electron donor comprises an organic material, preferably a polymeric material, such as PVA, PVC, PEG, polyethylene oxide, hydroxyethyl cellulose or a mixture thereof an amine, such as EDTA, triethylamine or a mixture thereof, an alcohol, a thiol, an aldehyde, or a mixture thereof.

In a further embodiment the oxygen-scavenging element 16 could comprise a layer comprising a carrier and a nanocrystalline activatable semiconductor dispersed therein. In one embodiment the carrier comprises a polymeric material.

In one embodiment the carrier could be a sacrificial electron donor, preferably a polymeric material, such as PVA, PVC, PEG, polyethylene oxide, hydroxyethyl cellulose or a mixture thereof.

In another embodiment the oxygen-scavenging element 16 could include a sacrificial electron donor dispersed in the carrier. In a particularly preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

In alternative embodiments the item 13, the oxygen-scavenging element 16 and the support 17 can be arranged differently, typically ordered differently, to provide for any arrangement thereof. For example, the oxygen-scavenging element 16 and the support 17 could be provided to the item 13 as a separate component of the packaging 14.

It will be understood that the package 11 of this embodiment is essentially a modification of the package 1 of the above-described first embodiment, and such a modification could be equally applied to the package 1 of the above-described second embodiment.

FIG. 4 illustrates a package 21 in accordance with a fourth embodiment of the present invention.

The package 21 comprises an item 23 and packaging 24 in which the item 23 is enclosed.

In preferred embodiments the item 23 can comprise an electronic or opto-electronic device, in particular one of a molecular or polymer-based electronic or opto-electronic device, foodstuff, pharmaceutical artefact, such as a museum piece, or another item, such as artwork, a metal or a medical instrument.

The packaging 24 comprises a container 25, in this embodiment an open-topped container, and an oxygen-scavenging element 26 including an activatable semiconductor, in this embodiment a film which closes, and preferably seals, the container 25, which is activatable to scavenge oxygen from within the package 21 and prevent the penetration of oxygen into the package 21.

In this embodiment the activatable semiconductor is a photo-activatable semiconductor, such as TiO₂, ZnO, WO₃ or any mixture thereof, which is activatable by ultra-bandgap light to scavenge available oxygen.

In this embodiment the oxygen-scavenging element 26 comprises a thin film.

In this embodiment the oxygen-scavenging element 26 comprises a layer comprising a carrier and a nanocrystalline activatable semiconductor dispersed therein. In one embodiment the carrier comprises a polymeric material.

In one embodiment the carrier could be a sacrificial electron donor, preferably a polymeric material, such as PVA, PVC, PEG, polyethylene oxide, hydroxyethyl cellulose or a mixture thereof.

In another embodiment the oxygen-scavenging element 26 could include a sacrificial electron donor dispersed in the carrier. In a preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

It is envisaged that this package 21 will find particular application in the packaging of a foodstuff where the oxygen-scavenging element 26 is a clear film which allows for the inspection of the contained foodstuff. This package 21 provides the additional advantage that the contained item is shielded from unnecessary and undesirable levels of ambient light, especially UV light. In this way, the oxygen-scavenging element 26 not only acts to reduce the concentration of oxygen in the package 21, thereby minimizing oxidative degradation of the item 23, that is, keeping the contained item fresher for longer periods where the item 23 is a foodstuff, but also reduce photo-degradation and discoloration by filtering out any undesirable UV light, typically as emitted by food cabinet lights.

FIG. 5 illustrates a package 21 in accordance with a fifth embodiment of the present invention.

This package 21 is very similar to the package 21 of the above-described fourth embodiment, and thus, in order to avoid unnecessary duplication of description, only the differences will be described in detail, with like parts being designated by like reference signs.

This package 21 differs from the package 21 of the above-described fourth embodiment only in that the packaging 24 is formed completely of the oxygen-scavenging element 26, in this embodiment as a film, with the container 25 being omitted.

FIG. 6 illustrates a package 31 in accordance with a sixth embodiment of the present invention.

The package 31 comprises an item 33 and packaging 34 in which the item 33 is enclosed.

The packaging 34 comprises a container 35, in this embodiment an open-topped container, an oxygen-scavenging element 36 including an activatable semiconductor which is activatable to scavenge oxygen from within the package 31 and prevent the penetration of oxygen into the package 31, and a support 37 for supporting the oxygen-scavenging element 36. In this embodiment the oxygen-scavenging element 36 and the support 37 together provide a film which closes, and preferably seals, the container 35, with the support 37 being an outer film and the oxygen-scavenging element 36 being an inner film.

In preferred embodiments the item 33 can comprise an electronic or opto-electronic device, in particular one of a molecular or polymer-based electronic or opto-electronic device, foodstuff, pharmaceutical, artefact, such as a museum piece, or other item, such as artwork, a metal or a medical instrument.

In this embodiment the activatable semiconductor is a photo-activatable semiconductor, such as TiO₂, ZnO, WO₃ or any mixture thereof, which is activatable by ultra-bandgap light to scavenge available oxygen.

In this embodiment the oxygen-scavenging element 36 comprises a thin film.

In this embodiment the support 37 comprises a polymeric material. In one embodiment the support 37 is a sacrificial electron donor, preferably PVA, PVC, PEG, polyethylene oxide, hydroxyethyl cellulose or a mixture thereof.

In this embodiment the oxygen-scavenging element 36 comprises a layer of a nanocrystalline activatable semiconductor.

In another embodiment the oxygen-scavenging element 36 could comprise a layer comprising a mixture of a nanocrystalline activatable semiconductor and a sacrificial electron donor. In a preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

In a further embodiment the oxygen-scavenging element 36 could comprise a layer comprising a carrier and a nanocrystalline activatable semiconductor dispersed therein.

In one embodiment the carrier comprises a polymeric material.

In one embodiment the carrier could be a sacrificial electron donor, preferably a polymeric material, such as PVA, PVC, PEG, polyethylene oxide, hydroxyethyl cellulose or a mixture thereof.

In another embodiment the oxygen-scavenging element 36 could include a sacrificial electron donor dispersed in the carrier. In a particularly preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

It will be understood that the package 31 of this embodiment is essentially a modification of the package 21 of the above-described fourth embodiment, and such a modification could be equally applied to the package 21 of the above-described fifth embodiment.

FIG. 7 illustrates a package 41 in accordance with a seventh embodiment of the present invention.

The package 41 comprises an item 43 and packaging 44 in which the item 43 is enclosed.

The packaging 44 comprises a container 45 and an oxygen-scavenging element 46 including an activatable semiconductor which is disposed within the container 45, which oxygen-scavenging element 46 is activatable to scavenge oxygen from within the package 41.

In preferred embodiments the item 43 can comprise an electronic or opto-electronic device, in particular one of a molecular or polymer-based electronic or opto-electronic device, foodstuff, pharmaceutical, artefact, such as a museum piece, or other item, such as artwork, a metal or a medical instrument.

In this embodiment the activatable semiconductor is a photo-activatable semiconductor, such as TiO₂, ZnO, WO₃ or any mixture thereof, which is activatable by ultra-bandgap light to scavenge available oxygen.

In this embodiment the oxygen-scavenging element 46 includes a nanocrystalline activatable semiconductor.

In this embodiment the oxygen-scavenging element 46 comprises a microporous block of a nanocrystalline activatable semiconductor. In a preferred embodiment the nanocrystalline activatable semiconductor could be dispersed in a carrier. In one embodiment the carrier comprises a polymeric material.

In one alternative embodiment the oxygen-scavenging element 46 could comprise a loose powder of a nanocrystalline activatable semiconductor, preferably contained in a receptacle, such as a sachet.

In another alternative embodiment the oxygen-scavenging element 46 could comprise a slurry of a nanocrystalline activatable semiconductor in a liquid carrier, preferably contained in a receptacle, such as a sachet.

In yet another alternative embodiment the oxygen-scavenging element 46 could comprise a paste of a nanocrystalline activatable semiconductor in a carrier, preferably contained in a receptacle, such as a sachet.

In a yet further alternative embodiment the oxygen-scavenging element 46 could comprise a gel of a nanocrystalline activatable semiconductor in a carrier, preferably contained in a receptacle, such as a sachet.

In another embodiment the oxygen-scavenging element 46 could include a sacrificial electron donor. In a preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

In one embodiment, where the oxygen-scavenging element 46 is formed as a block, the sacrificial electron donor could comprise a powder which is co-formed with the nanocrystalline activatable semiconductor.

In another embodiment, where the oxygen-scavenging element 46 is formed as a block, the sacrificial electron donor could comprise a carrier within which the nanocrystalline activatable semiconductor is dispersed.

In a further embodiment, where the oxygen-scavenging element 46 is formed as a block, the sacrificial electron donor could comprise a powder which is dispersed with the nanocrystalline activatable semiconductor in a carrier. In one embodiment the carrier comprises a polymeric material.

In a yet further embodiment, where the oxygen-scavenging element 46 is formed as a slurry, the sacrificial electron donor could comprise the carrier within which the nanocrystalline activatable semiconductor is dispersed.

In a still yet further embodiment, where the oxygen-scavenging element 46 is formed as a paste, the sacrificial electron donor could comprise the carrier within which the nanocrystalline activatable semiconductor is dispersed.

In still yet another embodiment, where the oxygen-scavenging element 46 is formed as a gel, the sacrificial electron donor could comprise the carrier within which the nanocrystalline activatable semiconductor is dispersed.

In still yet other embodiments the sacrificial electron donor could comprise a gas or a vapor.

FIG. 8 illustrates a package 51 in accordance with an eighth embodiment of the present invention.

The package 51 comprises an item 53, as a component, in this embodiment one of an electronic or opto-electronic device, and in particular one of a molecular or polymer-based electronic or opto-electronic device, and packaging 54 which includes an oxygen-scavenging element 56 including an activatable semiconductor, in this embodiment a layer encapsulating an active surface of the item 53, which is activatable to scavenge oxygen and prevent the penetration of oxygen to the active surface of the item 53.

In this embodiment the activatable semiconductor is a photo-activatable semiconductor, such as TiO₂, ZnO, WO₃ or any mixture thereof, which is activatable by ultra-bandgap light to scavenge available oxygen.

In this embodiment the oxygen-scavenging element 56 comprises a thin film.

In this embodiment the oxygen-scavenging element 56 comprises a layer of a nanocrystalline activatable semiconductor.

In another embodiment the oxygen-scavenging element 56 could comprise a layer comprising a mixture of a nanocrystalline activatable semiconductor and a sacrificial electron donor. In a preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

In a further embodiment the oxygen-scavenging element 56 could comprise a layer comprising a carrier and a nanocrystalline activatable semiconductor dispersed therein.

In one embodiment the carrier comprises a polymeric material.

In one embodiment the carrier could be a sacrificial electron donor, preferably a polymeric material, such as PVA, PVC, PEG, polyethylene oxide, hydroxyethyl cellulose or a mixture thereof.

In another embodiment the oxygen-scavenging element 56 could include a sacrificial electron donor dispersed in the carrier. In a preferred embodiment the sacrificial electron donor comprises an organic material, preferably a polymeric material, such as PVA, PVC, PEG, polyethylene oxide, hydroxyethyl cellulose or a mixture thereof, an amine, such as EDTA, triethylamine or a mixture thereof, an alcohol, a thiol, an aldehyde, or a mixture thereof.

The package 51 further comprises a reference electrode 58 and a voltage supply 59 for biasing the packaging 54 to a potential which provides for electro-activation of the oxygen-scavenging element 56.

In one mode of operation, the oxygen-scavenging element 56 can be electrically activated by the application of a potential thereto using the voltage supply 59.

In another mode of operation, the oxygen-scavenging element 56 can be activated by a combination of both electro-activation through the application of a potential thereto using the voltage supply 59 and photo-activation through the application of ultra-bandgap light thereto.

It is envisaged that this package 51 will find particular application in the protection of electrical components from oxygen where photo-activation is not convenient.

The present invention will now be exemplified with reference to the following non-limiting Examples.

### EXAMPLE 1

A sample packaging 44 was prepared in accordance with the above-described seventh embodiment, where comprising a 0.5 cm³ container 45 and an oxygen-scavenging element 46 comprising a film of nanocrystalline TiO₂ on a glass slide and methanol in the vapor phase, where the methanol acts a sacrificial electron donor.

The sample packaging 44 was irradiated with an ultra-violet (365 nm) lamp (VL-208BL, intensity 1400 μW/cm²), and the oxygen concentration within the container 45 was measured using an oxygen measurement electrode (as supplied by Rank Brothers Ltd, Cambridge, UK).

The measured oxygen concentration, where normalised, as a function of the period of irradiation is illustrated in FIG. 9. As will be noted, the oxygen-scavenging element 46 scavenges the closed environment rapidly, and maintains the de-oxygenated state.

### EXAMPLE 2

A sample packaging 44 was prepared in accordance with the above-described seventh embodiment, where comprising a 0.5 cm³ container 45 and an oxygen-scavenging element 46 comprising a film of a mixture of nanocrystalline TiO₂ and polyethylene glycol (PEG, Mₙ ca. 1500) deposited from an aqueous suspension by doctor blading onto a glass slide and subsequently drying in air, where the PEG acts a sacrificial electron donor.

The sample packaging 44 was irradiated with an ultra-violet (365 nm) lamp (VL-208BL, intensity 1400 μW/cm²), and the oxygen concentration within the container 45 was measured using an oxygen measurement electrode (as supplied by Rank Brothers Ltd, Cambridge, UK).

The measured oxygen concentration, where normalised, as a function of the period of irradiation is illustrated in FIG. 10. As will be noted, the oxygen-scavenging element 46 scavenges oxygen from the closed environment quite rapidly, and maintains the de-oxygenated state.

Finally, it will be understood that the present invention has been described in its preferred embodiments and can be modified in many different ways without departing from the scope of the invention as defined by the appended claims.

1. A package packaging an item and defining a closed environment in which the item is enclosed, the packaging including an oxygen-scavenging element which includes a photo-activatable semiconductor and an electron donor, wherein the semiconductor, whilst exposed to ultra-bandgap light, generates electron-hole pairs, with the electrons acting to reduce oxygen, and thereby scavenge the same from the closed environment, and the holes combining with electrons sacrificed by the electron donor.

2. The package of claim 1, wherein the electron donor comprises an organic material.

3. The package of claim 2, wherein the organic material comprises a polymeric material.

4. The package of claim 3, wherein the polymeric material comprises PVA, PVC, PEG, polyethylene oxide, hydroxyethyl cellulose, or a mixture thereof.

5. The package of claim 2, wherein the organic material comprises an amine.

6. The package of claim 5, wherein the amine comprises EDTA, triethylamine, or a mixture thereof.

7. The package of claim 2, wherein the organic material comprises an alcohol.

8. The package of claim 2, wherein the organic material comprises a thiol.

9. The package of claim 2, wherein the organic material comprises an aldehyde.

10. The package of claim 1, wherein the electron donor comprises a liquid.

11. The package of claim 1, wherein the electron donor comprises a solid.

12. The package of claim 1, wherein the electron donor comprises a gas.

13. The package of claim 1, wherein the electron donor comprises a vapor.

14. The package of claim 1, wherein the semiconductor comprises an oxide semiconductor.

15. The package of claim 14, wherein the semiconductor comprises TiO₂.

16. The package of claim 14, wherein the semiconductor comprises ZnO.

17. The package of claim 14, wherein the semiconductor comprises WO₃.

18. The package of claim 14, wherein the semiconductor comprises at least two of TiO₂, ZnO and WO₃.

19. The package of claim 1, wherein the oxygen-scavenging element comprises a suspension containing the semiconductor.

20. The package of claim 1, wherein the oxygen-scavenging element comprises a paste containing the semiconductor.

21. The package of claim 1, wherein the oxygen-scavenging element comprises a gel containing the semiconductor.

22. The package of claim 1, wherein the oxygen-scavenging element comprises a solid containing the semiconductor.

23. The package of claim 22, wherein the oxygen-scavenging element comprises a block containing an activatable semiconductor.

24. The package of claim 22, wherein the oxygen-scavenging element comprises a layer containing an activatable semiconductor.

25. The package of claim 22, wherein the oxygen-scavenging element comprises a powder containing an activatable semiconductor.

26. The package of claim 1, wherein the oxygen-scavenging element comprises an encapsulating layer encapsulating at least a surface of the item.

27. The package of claim 1, wherein the packaging comprises a film packaging defined at least in part by the oxygen-scavenging element.

28. The package of claim 1, wherein the packaging includes an open-topped container and the oxygen-scavenging element comprises a film which closes the container.

29. The package of claim 1, wherein the packaging includes a closed container and the oxygen-scavenging element is disposed within the container.

30. The package of claim 1, wherein the item comprises an electronic device.

31. The package of claim 1, wherein the item comprises an opto-electronic device.

32. The package of claim 30, wherein the item comprises a molecular device.

33. The package of claim 30, wherein the item comprises a polymeric device.

34. The package of claim 1, wherein the item comprises a foodstuff.

35. Use of an oxygen-scavenging element including a photo-activatable semiconductor and an electron donor in a package, which packages an item and defines a closed environment in which the item is enclosed, to scavenge oxygen from the closed environment whilst exposed to ultra-bandgap light.
